(19) United States
(12) Patent Application Publication
(10) Pub. No.: US 2025/0137541 A1
(43) Pub. Date: May 1, 2025

(54) Rotational Valves for Hot Water Systems

(71) Applicant: Rheem Manufacturing Company, Atlanta, GA (US)

(72) Inventors: Brandon Haggerty, Prattville, AL (US); Saman Beyhaghi, Opelika, AL (US); Anthony Hurgoi, Boston, MA (US); Harsha Satyanarayana, Norwalk, CT (US); Christopher Mark Hayden, Shelton, CT (US); Thanh Hoang Dao, West Hartford, CT (US)

(21) Appl. No.: 18/896,084

(22) Filed: Sep. 25, 2024

Related U.S. Application Data
(60) Provisional application No. 63/594,201, filed on Oct. 30, 2023.

(51) Int. Cl. F16K 11/085; F24H 15/174; F24H 15/315; G05D 23/19

(52) U.S. Cl. CPC F16K 11/0856; F24H 15/174; F24H 15/315; G05D 23/1931

(57) ABSTRACT

A rotational valve is provided for a hot water system. The hot water system has a cold inlet and a hot outlet. The rotational valve includes a housing and a flow director. The housing includes a body, a first conduit provided with the body and being structured to be coupled to the cold inlet, a second conduit provided with the body and being structured to be coupled to the hot outlet, and a bypass chamber provided with the body. The flow director is located within the body and is structured to direct water from the cold inlet and water from the hot outlet into the bypass chamber.

### CROSS-REFERENCE TO RELATED APPLICATIONS

This application claims priority to and the benefit of U.S. provisional application No. 63/594,201, filed Oct. 30, 2023, which is hereby incorporated by reference herein in its entirety.

### FIELD

This application is directed to systems and methods for heating water and more particularly to rotational valves for mixing hot water with cooler water in order to lower a temperature of the hot water to a desired end use temperature.

### BACKGROUND

Hot water systems used in residential, commercial, and/or industrial applications commonly include hot water tanks. In some instances, heated water (e.g., from the hot water tanks) may be combined with cooler water in order to increase the volume of hot water to be delivered (e.g., from the hot water tanks). That is, the water within the hot water tanks may be heated to a temperature greater than a desired end use temperature. The hot water from the hot water tanks may then be mixed with cooler water at an outlet of the hot water tanks in order to lower the temperature of the hot water to the desired end use temperature. In some instances, cooling the water commonly includes employing a plurality of valves in order to bleed cold water from a cold-water line (e.g., that is entering the hot water tank) into the hot water that is exiting the hot water tank. These prior art valves often employ bimetal springs to meter the mixing of the hot and cooler water. It is with respect to these and other considerations that the instant disclosure is concerned.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a schematic view of a hot water system and a rotational valve for the same in accordance with one or more embodiments of the present disclosure.

FIG. 2 shows an isometric view of a portion of the hot water system and rotational valve of FIG. 1 in accordance with one or more embodiments of the present disclosure.

FIG. 3 shows an isometric view of the rotational valve of FIG. 2 in accordance with one or more embodiments of the present disclosure.

FIG. 4 shows an isometric view of a housing for the rotational valve of FIG. 3 in accordance with one or more embodiments of the present disclosure.

FIG. 5 shows an isometric view of a flow director for the rotational valve of FIG. 3 in accordance with one or more embodiments of the present disclosure.

FIG. 6 shows an isometric view of the rotational valve of FIG. 3 with the flow director in a first position in accordance with one or more embodiments of the present disclosure.

FIG. 7 shows an isometric view of the rotational valve of FIG. 3 with the flow director in a second position in accordance with one or more embodiments of the present disclosure.

FIG. 8 shows an isometric view of the rotational valve of FIG. 3 with the flow director in a third position in accordance with one or more embodiments of the present disclosure.

FIG. 9 shows an isometric view of another embodiment of a rotational valve in accordance with one or more embodiments of the present disclosure.

### DETAILED DESCRIPTION

The apparatuses, systems, and methods disclosed herein may assist at least in part in controlling the temperature of water that is being delivered to various locations in residential, commercial, and/or industrial applications. For example, in some instances, a hot water system is provided herein and may include a hot water tank having a cold inlet and a hot outlet. In other instances, the hot water may be provided via a tankless water system. Any suitable means may be used to produce the hot water, including heat pump systems, electric heating elements, combustion heaters, solar heaters, or the like and combinations thereof. The hot water system also may include a rotational valve. The rotational valve advantageously may allow for the temperature of water to be controlled by way of a single mixing valve.

More specifically, some of the water from the cold inlet (e.g., cold water which may be entering a hot water tank) and the water from the hot outlet (e.g., hot water which may be exiting the hot water tank or other hot water source) may be combined in, at, or by the rotational valve and then delivered to an end user, such as, for example, a shower head or faucet in a residence. In some instances, the rotational valve may include a housing and a flow director located within the housing. The flow director may be configured to rotate about an axis within the housing. In certain embodiments, the flow director may be cylindrical shaped and have different grooved regions that are each aligned with and configured to direct water from a corresponding one of the cold inlet and the hot outlet into a bypass chamber. In this manner, the grooved regions may form flow paths for water when the flow director is rotated into one or more flow positions. In the bypass chamber, the water may be combined and then delivered to various locations throughout a residential, commercial, and/or industrial environment.

In certain embodiments, in order to control the temperature of the water exiting the bypass chamber, the hot water system further may include an actuator, a controller, and a number of sensors. The sensors may be configured to measure the temperature of the water in the hot water tank and the temperature of the water exiting the bypass chamber. The sensors also may be configured to send real time temperature data to the controller. In some instances, the actuator may be coupled to the flow director in order to cause the flow director to rotate within the housing of the rotational valve. For example, when the controller receives the real time temperature data from the sensors, the controller may determine how much hot water from the hot water tank and cold water from the cold inlet to allow to pass through the rotational valve. Based on this information, the actuator may rotate the flow director to allow for the appropriate amount of mixing. This rotation of the flow director may allow the temperature to be changed from a first temperature to a preferred temperature.

For example, if the controller determines that the temperature of the water exiting the rotational valve is below the preferred temperature (e.g., via the temperature sensors), the controller can send a signal to the actuator to rotate the flow director such that (i) a grooved region associated with the hot outlet may allow more water to pass therethrough and (ii) a grooved region associated with the cold inlet may allow less water to pass therethrough. In this manner, the combined water will then warm up as it exits the bypass chamber of the rotational valve. In contrast, if the controller determines that the temperature of the water exiting the rotational valve is above the preferred temperature (e.g., via the temperature sensors), the controller can send a signal to the actuator to rotate the flow director such that (i) a grooved region associated with the hot outlet may allow less water to pass therethrough and (ii) a grooved region associated with the cold inlet may allow more water to pass therethrough. Accordingly, it will be appreciated that the hot water system provided herein advantageously may allow for the temperature of water exiting the bypass chamber to be controlled in real time. That is, if the sensors determine that the temperature of the water exiting the bypass chamber is deviated from the preferred temperature, the controller can automatically cause the flow director to rotate clockwise or counterclockwise to warm or cool the exiting water by allowing either (i) more hot water and less cold water or (ii) less hot water and more cold water to pass through the rotational valve. In other instances, the rotational valve may be rotated such that neither grooved region forms a flow path. In such instances, the rotational valve may act as a shutoff valve.

Additionally, in one example, the hot water system includes one single valve, and that valve is the rotational valve. This is advantageous as compared to known systems, which often include a plurality of valves to allow for bleeding (e.g., mixing by introducing liquid from a first line into a second line) of cold water from cold inlets to be combined with hot water from hot outlets of hot water tanks.

These and other advantages of the present disclosure are provided in greater detail herein.

As employed herein, the term “number” shall mean one or an integer greater than one (e.g., a plurality). As employed herein, the term “coupled” shall mean connected together either directly or via one or more intermediate parts or components.

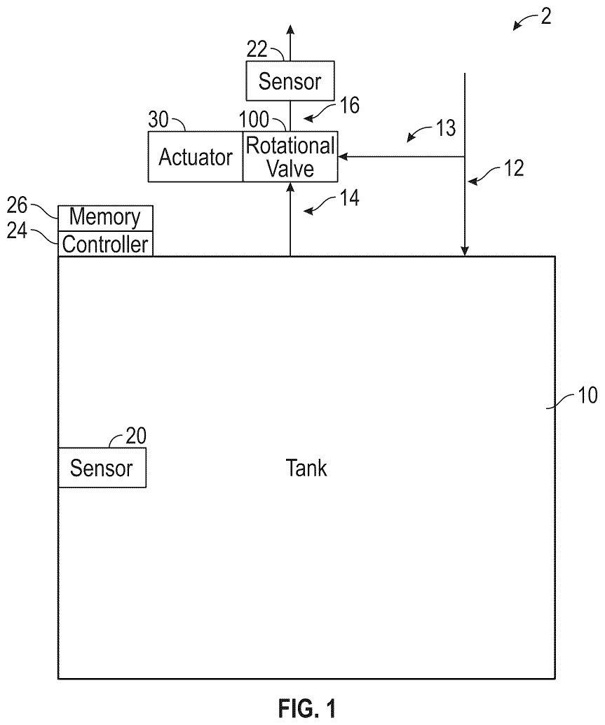

Turning now to the drawings, FIG. 1 is a schematic view of a hot water system 2 in accordance with one or more embodiments of the present disclosure. The hot water system 2 may include a hot water tank 10 having a cold inlet 12 and a hot outlet 14. In some instances, the cold inlet 12 may be a conduit and/or a plurality of conduits for directing cold water into the hot water tank 10 and for bleeding water into a rotational valve 100 via a bleed line 13. The hot outlet 14 may be a conduit for directing hot water which exits the hot water tank 10 into the rotational valve 100. In one example, at least some water entering the hot water tank 10 at the cold inlet 12 may be combined via the bleed line 13 with water exiting the hot water tank 10 at the hot outlet 14 to yield combined water. In this manner, the hot water system 2 is advantageously able to deliver larger volumes of heated water because the hot water tank 10 can contain a relatively small volume of relatively hotter water, which can be combined via the bleed line 13 with water from the cold inlet 12 and thus be delivered to various outlets throughout a residential, commercial, and/or industrial environment.

In some instances, the hot water tank 10 may be omitted. In this manner, the hot water system 2 may be a tankless system. In some instances, the cold inlet 12 may be a conduit and/or a plurality of conduits for directing cold water into the heating element of the tankless system and for bleeding water into the rotational valve 100 via the bleed line 13. The hot outlet 14 may be a conduit for directing hot water which exits the heating element of the tankless system into the rotational valve 100. In one example, at least some water entering the heating element of the tankless system at the cold inlet 12 may be combined via the bleed line 13 with water exiting the heating element of the tankless system at the hot outlet 14 to yield combined water.

Still referring to FIG. 1, and in accordance with one or more embodiments, the hot water system 2 may include a mechanism for controlling the temperature of the combined water. In order to perform this function, the hot water system 2 may include a number of sensors (e.g., a first sensor 20 and a second sensor 22), a controller 24 (which may include a processor or the like), a memory 26, an actuator 30 (e.g., a servo or stepper motor), and a rotational valve 100 coupled to the actuator 30. The controller 24 may be a commercially available general-purpose controller, such as a controller from the Intel® or ARM® architecture families. Any suitable controller or similar computing device and processors may be used herein. The controller 24 may be in electrical communication (e.g., wired or wirelessly) with the various components of the water system 2. For example, the controller 24 may be in communication with the sensors 20, 22 and the actuator 30, among other components. The memory 26 may be a non-transitory computer-readable memory storing program code and can include any one or a combination of volatile memory elements (e.g., dynamic random access memory (DRAM), synchronous dynamic random access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc. Any suitable memory may be used herein.

In certain embodiments, the sensors 20, 22, the controller 24, the memory 26, the actuator 30, and the rotational valve 100 may be configured to control the temperature of water in the hot water system 2. For example, the first sensor 20 may be coupled to and configured to measure a temperature of water in the hot water tank 10. The second sensor 22 may be coupled to a conduit 16 through which the combined water flows. In this manner, the second sensor 22 may be configured to measure a temperature of the combined water exiting the rotational valve 100. Additionally, the controller 24 may be electrically connected to the first and second sensors 20, 22, and be configured to receive real time temperature data from the first and second sensors 20, 22. As will be discussed in greater detail below, the first and second sensors 20, 22 may each be configured to measure temperatures of water in the hot water tank 10 and water exiting the rotational valve 100, respectively. Based on data from the sensors 20, 22, the controller 24 may be configured to adjust the temperature of the combined water via movement of the actuator 30 and the rotational valve 100, as will be more apparent below.

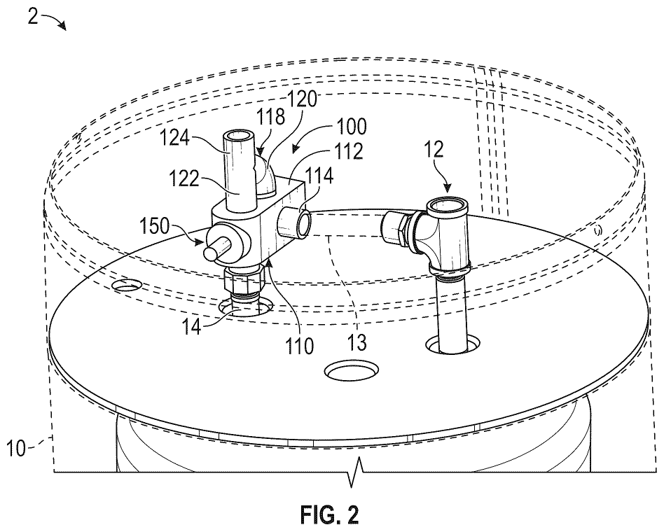

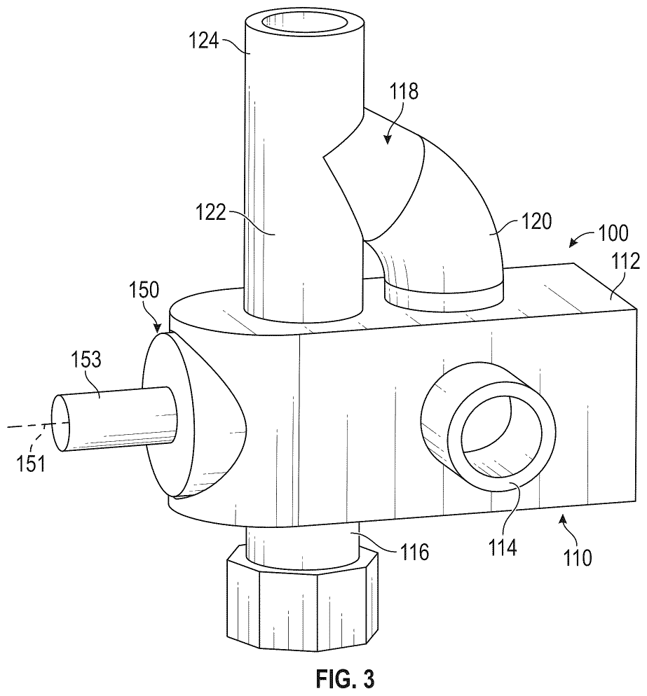

FIG. 2 shows another view of portions of the hot water system 2, and FIG. 3 shows an isometric view of the rotational valve 100. As depicted in FIG. 2, the rotational valve 100 may be disposed about the hot outlet 14. In some instances, the rotational valve 100 may be disposed above the top pan of the hot water tank 10 and may be an aftermarket component. In other instances, the rotational valve 100 may be disposed below the top pan and foamed in about the hot water tank 10 during manufacturing. In yet other instances, the rotational valve 100 may include a shell or casing disposed around the rotational valve 100 that may include insulation or the like.

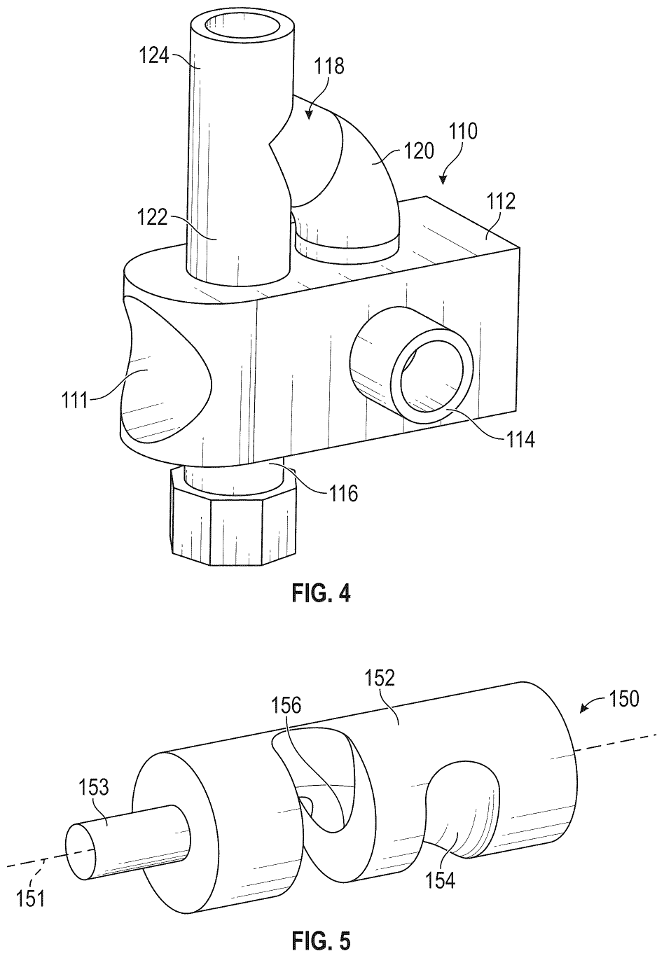

As shown in FIG. 3, the rotational valve 100 may include a housing 110 (see also FIG. 4) and a flow director 150 (see also FIG. 5) located at least partially within the housing 110. It will be appreciated that the rotational valve 100 may further include a gasket (not shown) or other suitable sealing mechanism between the housing 110 and the flow director 150 in order to ensure that water does not escape therebetween. The housing 110 may include a body 112, a first conduit 114 provided with (e.g., extending outwardly from or within) the body 112 and being structured to be coupled to the cold inlet 12 (FIGS. 1 and 2) (e.g., via a conduit 13), a second conduit 116 provided with (e.g., extending outwardly from or within) the body 112 and being structured to be coupled to the hot outlet 14 (FIGS. 1 and 2), and a bypass chamber 118 provided with (e.g., extending outwardly from or within) the body 112. In one example, the housing 110 and the flow director 150 may each be unitary components made from single pieces of material (e.g., injection molded or 3D printed pieces). In this manner, in some instances, the rotation valve 100 may be formed of two pieces, the housing 110 (which may be stationary) and the flow director 150 (which may rotate at least partially within the housing 110). In other embodiments, the housing 110 and the flow director 150 may each be formed of multiple pieces that are suitably coupled to one another.

In certain embodiments, the flow director 150 may be located within the body 112 and may be structured to direct water from the cold inlet 12 (FIGS. 1 and 2) and/or water from the hot outlet 14 (FIGS. 1 and 2) to combine them. In this manner, in certain embodiments, combining of water from the cold inlet 12 and the hot outlet 14 is advantageously able to be achieved via one single valve (e.g., the rotational valve 100). That is, the hot water system 2 may include one single rotatable valve for receiving water from both the cold inlet 12 and the hot outlet 14 and directing the combined water outwardly therefrom, that valve being the rotational valve 100. This is distinct from typical hot water systems, which typically require at least two separate valves to combine water from cold inlets and hot outlets. Accordingly, the hot water system 2 may be advantageously easier to assemble than typical systems.

As stated above, the hot water system 2 disclosed herein may advantageously allow for the temperature of the combined water in the conduit 16 to be controlled in a reliable manner. More specifically, and as will be more apparent below, the first and second sensors 20, 22 may provide feedback (e.g., via wireless signals or otherwise) to the controller 24, which in turn may send a signal to the actuator 30 based on the feedback from the first and second sensors 20, 22. Furthermore, the actuator 30 may be coupled to the flow director 150 and as such may cause the flow director 150 to allow variable amounts of cold and/or hot water to pass through the rotational valve 100, thereby allowing for a controlled temperature of the combined water through the conduit 16.

Referring to FIG. 5, in certain embodiments, the flow director 150 may be substantially cylindrical-shaped and configured to rotate about an axis 151 within the body 112 of the housing 110. It will thus be appreciated that the housing 110 (FIG. 4) may have an opening 111 for receiving the flow director 150 partially or entirely therethrough. Referring again to FIG. 5, the flow director 150 may include a body 152 and a drive shaft 153 extending outwardly from the body 152. In some instances, the drive shaft 153 may be concentric with the axis 151. In other instances, the drive shaft 153 may be offset from the axis 151. The drive shaft 153 may be coupled to the actuator 30 (FIG. 1). In this manner, the drive shaft 153 may be configured to be rotated by the actuator 30, which in turn may rotate the body 152 of the flow director 150. More specifically, in certain embodiments, the controller 24 (FIG. 1), based on temperature data received from the first sensor 20 and the second sensor 22, may be configured to cause the actuator 30 to rotate the drive shaft 153, which in turn may rotate the body 152 of the flow director 150 in order to change the temperature of water in the conduit 16 in real time to a preferred temperature. In one example embodiment, the preferred temperature of the water in the conduit 16 is between 110-120 degrees Fahrenheit, and the temperature of the water in the hot water tank 10 is between 140-180 degrees Fahrenheit.

Still referring to FIG. 5, the body 152 of the flow director 150 may include a first grooved region 154 and a second grooved region 156. In some instances, the grooved regions 154, 156 may be channels which are cut out of the body 152. In this manner, the grooved regions 154, 156 and the inner wall of the body 112 may form fluid passages or channels therebetween. In some instances, seals, gaskets, or other suitable sealing mechanisms may be disposed around the grooved regions 154, 156 between the inner wall of the body 112 to form fluid passages or channels therebetween. In one example, the grooved regions 154, 156 may be a semicircle groove, wherein the second grooved region 156 may wrap around the body 152 of the flow director 150 about 150-210 degrees (e.g., 180 degrees in one embodiment) in order to reduce pressure drop across the valve body during normal operation, and the first grooved region 154 may cut into the body 152 of the flow director 150 at an upward angle to allow easy transition for water to move across a 90 degree angle and reduce pressure drop. In some instances, the first grooved region 154 may form a flow path for water from the cold inlet 12 into the conduit 16 via the bypass chamber 118 of the housing 110. Similarly, in some instances, the second grooved region 156 may form a flow path for water from the hot outlet 14 into the conduit 16. In this manner, the first and second grooved regions 154, 156 may allow variable amounts of water from the cold inlet 12 and the hot outlet 14 to pass into the conduit 16 depending on the rotational position of the body 152 of the flow director 150. More specifically, the first grooved region 154 may be configured to direct the water from cold inlet 12 into the conduit 16 via the bypass chamber 118 of the housing 110, and the second grooved region 156 may be configured to direct the water from the hot outlet 14 into the conduit 16. Additionally, as shown, the first and second grooved regions 154, 156 each define openings. In some instances, the opening defined by the first grooved region 154 may be smaller (e.g., have surfaces defining the opening that have smaller surface area than surfaces defining the opening of second grooved region 156) than the opening defined by the second grooved region 156. In this manner, and as will be further discussed below, the first grooved region 154 may be configured to allow less water to pass therethrough than the first grooved region 156. Accordingly, the contoured surfaces (e.g., curved and/or planar in alternative examples) of the grooved regions 154, 156 may be configured to direct variable amounts of water from the cold inlet 12 and the hot outlet 14 into the conduit 16. For example, in some instances, more hot water from the hot outlet 14 is provided into the conduit 16 than cold water from the cold inlet 12.

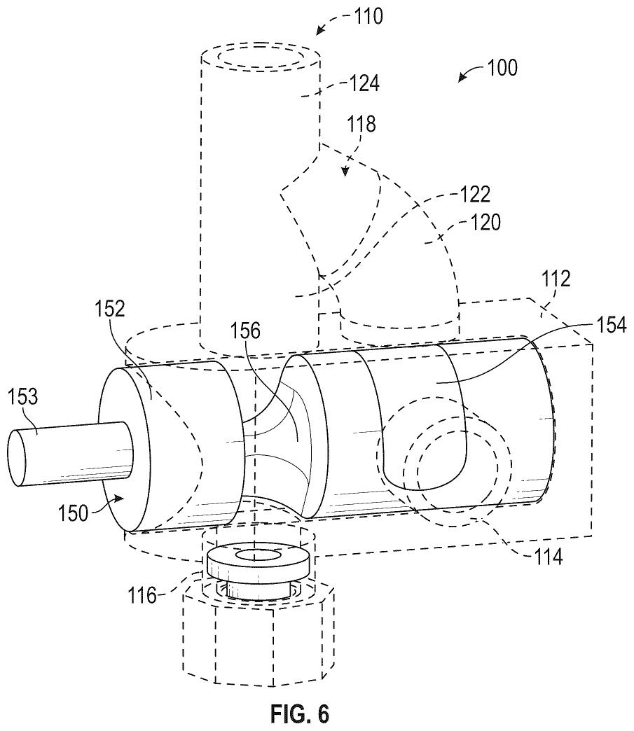

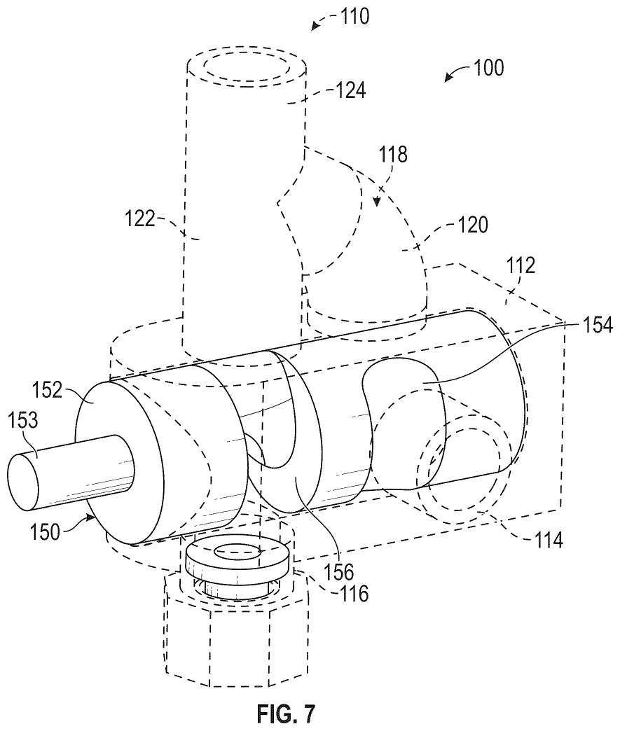

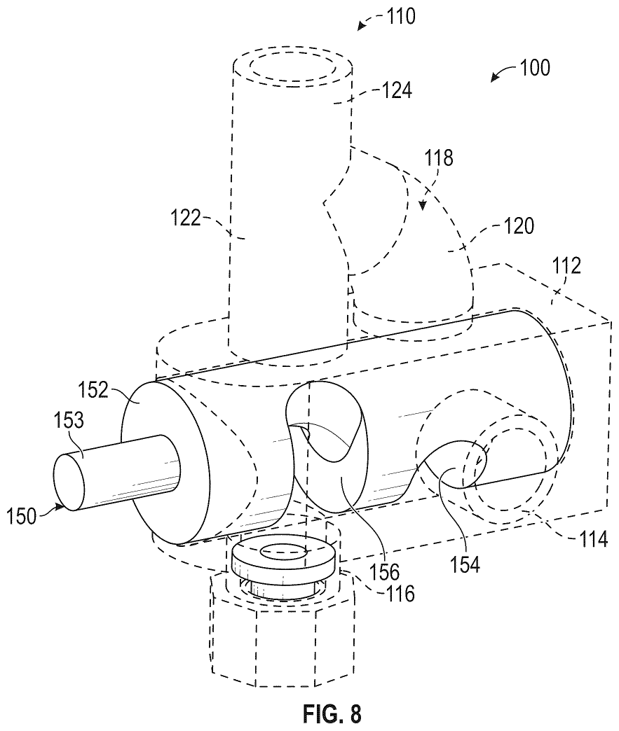

Referring to FIGS. 6-8, operation of the rotational valve 100 will now be described. As shown in FIGS. 6-8, the flow director 150 selectively may be positionable in at least three different positions. In the first position, as depicted in FIG. 6, the first grooved region 154 and the second grooved region 156 are configured to provide for “open” states for water entering the rotational valve 100 from the cold inlet 12 and the hot outlet 14, respectively. In the second position, as depicted in FIG. 7, the first grooved region 154 can be considered to be in a “closed” state wherein water from the cold inlet 12 may be substantially or entirely blocked from passing through the rotational valve 100. More so, in the second position, the second grooved region 156 may be considered to be in the “open” state such that water from the hot outlet 14 may substantially or entirely pass through the rotational valve 100. Finally, in the third position, as depicted in FIG. 8, both the first and second grooved regions 154, 156 may be considered to be in a “closed” state such that water from the cold inlet 12 and the hot outlet may substantially or entirely be blocked from passing therethrough.

In this manner, the flow director 150 may include a plurality of different positions with respect to the housing 110. That is, the body 152 of the flow director 150 may be rotated within the housing 110 between the various positions in order to “open” or “close” one or more flow paths thereabout from the cold inlet 12 and/or the hot water outlet 114 into the conduit 116. For example, the flow director 150 can be in one of the first and third positions depicted in FIGS. 6 and 8 and can also be in any of the incremental positions in between (e.g., the second position of FIG. 7 or another position between the first and third positions). Each of these pluralities of positions (and all incremental positions therebetween) may correspond to a different proportion of water from the cold inlet 12 and the hot outlet 14 being directed through the rotational valve 100 to the conduit 16. In this manner, in accordance with certain embodiments, by knowing the temperatures of water in the hot water tank 10 and the conduit 16, e.g., via the first and second sensors 20, 22 (FIG. 1), the controller 24 (FIG. 1) can cause rotation of the flow director 150 to a position corresponding to a certain, predetermined amount of cold and hot water being directed therethrough in order for the temperature of water in the conduit 16 to move from an operating temperature to a preferred temperature. This may be desirable because oftentimes in typical systems, water exiting valves of hot water systems may be too hot or too cold. By measuring the temperatures with the first and second sensors 20, 22 (e.g., the first sensor 20 measures the temperature of the water in the hot water tank 10 and the second sensor 22 measures the temperature of the water exiting the bypass chamber 118) and rotating the rotational valve 100 as described herein, the temperature of the water in the conduit 16 can be tuned to reach the preferred temperature.

Referring again to FIG. 4, the bypass chamber 118 may include a third conduit 120 and a fourth conduit 122, which may be provided with (e.g., extending outwardly from or within) the body 112 and be parallel or nearly parallel (e.g., each having axis disposed within 10 degrees of one another) to one another. In some instances, the third and fourth conduits 120, 122 may each be configured to receive a corresponding one of water from the cold inlet 12 via the bleed line 13 and/or the hot outlet 14 after the water from the cold inlet 12 and the hot outlet 14 has passed through a corresponding one of the first and second grooved regions 154, 156. The bypass chamber 118 may also include a fifth conduit 124 extending from and being structured to receive water from the third and fourth conduits 120, 122. In certain embodiments, the fifth conduit 124 may be coupled to and/or form part of the conduit 16 (FIG. 1) of the hot water system 2 (FIGS. 1 and 2), thus allowing for the water through the third and fourth conduits 120, 122 to exit the rotational valve 100 and be passed to various outlets in the residential, commercial, and/or industrial environment. In some instances, the conduits 114, 116, 120, 122, 124 may be oriented perpendicular to the body 112 of the housing 110. For example, as shown, the conduits 114, 116, 120, and 122 extend about axis that are oriented perpendicular to surfaces of the body 112. In alternative examples, conduits may extend about axis oriented at acute or obtuse angles with respect to surfaces of a body. The conduits 114, 116, 120, 122, 124 may be any suitable size, shape, or configuration. More so, in some instances, at least a portion of the bypass chamber 118 may be formed by all or part of the conduits 120, 122, 124. That is, the water from the cold inlet 12 and the hot outlet 14 may be mixed/combined wholly or partially in the bypass chamber 118, the conduits 120, 122, 124, and/or a combination thereof.

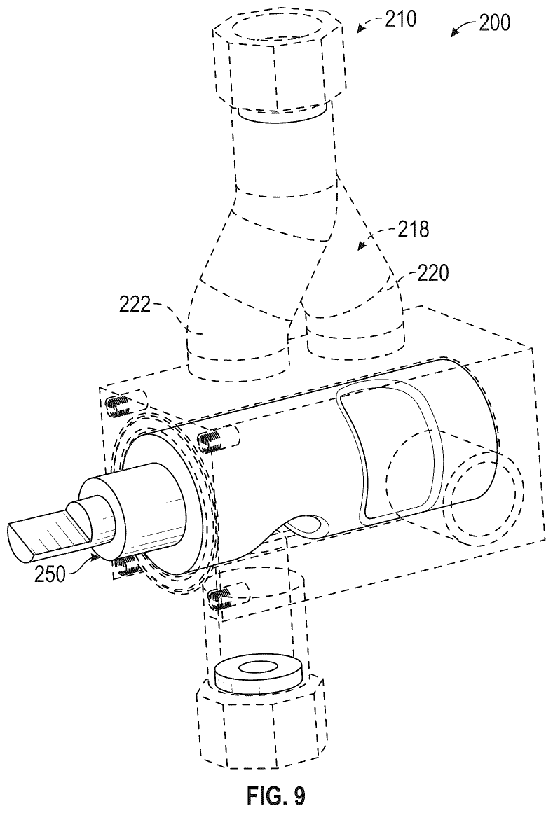

FIG. 9 shows another embodiment of a rotational valve 200 that may be used in the hot water system 2 in place of the rotational valve 100. The rotational valve 200 may be substantially the same as the rotational valve 100 (e.g., the rotational valve 200 may include a housing 210 and a flow director 250 that function similar to the housing 110 and flow director 150) and like numbers represent like features (e.g., 120 and 220 both define conduits). In the example of FIG. 9, the third and fourth conduits 220, 222 of the bypass chamber 218 may, for example, be symmetrical and have substantially the same length for water to flow therethrough. In this manner, a reduced pressure drop may be provided to the hot outlet 14 and improved mixing between the hot outlet 14 and the cold inlet 12.

Moreover, it will be appreciated that a method of operating the hot water system 2 may include mixing hot and cooler water using one single valve 100. The methods may include the steps of providing the hot water system 2 with a tank 10 having a cold inlet 12 and a hot outlet 14. The method may also include providing the one single valve 100 as a rotational valve 100 having a housing 110 and a flow director 150. As noted above, the housing 110 may include the body 112, the first conduit 114, the second conduit 116, and the bypass chamber 118. The flow director 150 may be located within the body 112. The method also may include providing a first sensor 20 and a second sensor 22 each configured to measure a temperature of a corresponding one of water in the tank 10 and water exiting the bypass chamber 118. Next, the method may include providing a controller 24 electrically connected to the first sensor 20 and the second sensor 22. The controller 24 may also be electrically connected to the actuator 30. In this manner, the method may include causing, by the controller, the flow director 150 to rotate based on data received from the first sensor 20 and the second sensor 24 in order to change the temperature of water exiting the bypass chamber 118 in real time to a preferred temperature. In some instances, causing the flow director 150 to rotate may include changing the flow rate of the water passing through the first and second grooved regions 154, 156 from a first flow rate to a second by rotating the body 152 of the flow director 150.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A rotational valve for a hot water system, the hot water system having a cold inlet and a hot outlet, the rotational valve comprising:
a housing comprising a body, a first conduit configured to be coupled to the cold inlet, a second conduit configured to be coupled to the hot outlet, and a bypass chamber; and
a flow director disposed within the body and configured to rotate about an axis within the body in order to direct at least a portion of water from the cold inlet and/or water from the hot outlet into the bypass chamber.

2. The rotational valve according to claim 1, wherein the flow director is substantially cylindrical-shaped.

3. The rotational valve according to claim 1, wherein the flow director comprises a body having a first grooved region and a second grooved region, wherein the first grooved region is configured to direct the water from the cold inlet into the bypass chamber, and wherein the second grooved region is configured to direct the water from the hot outlet into the bypass chamber.

4. The rotational valve according to claim 3, wherein the first grooved region defines a first opening in the flow director, wherein the second grooved region defines a second opening in the flow director, and wherein the first opening is smaller than the second opening.

5. The rotational valve according to claim 3, wherein the flow director further comprises a drive shaft extending outwardly from the body, and wherein the drive shaft is configured to be coupled to an actuator.

6. The rotational valve according to claim 3, wherein the bypass chamber comprises a third conduit and a fourth conduit, wherein the third conduit and the fourth conduit are each configured to receive a corresponding one of the water from the cold inlet and the water from the hot outlet, after the water from the cold inlet and the water from the hot outlet have passed through a corresponding one of the first grooved region and the second grooved region.

7. The rotational valve according to claim 6, wherein the bypass chamber further comprises a fifth conduit connected to and structured to receive water from the third conduit and the fourth conduit.

8. A hot water system comprising:
a cold inlet and a hot outlet; and
a rotational valve comprising:
a housing comprising a body, a first conduit configured to be coupled to the cold inlet, a second conduit configured to be coupled to the hot outlet, and a bypass chamber; and
a flow director disposed within the body and configured to rotate about an axis within the body in order to direct water from the cold inlet and water from the hot outlet into the bypass chamber.

9. The hot water system according to claim 8, further comprising a tank having the cold inlet and the hot outlet, wherein the hot water system further comprises a first sensor coupled to and configured to measure a temperature of water in the tank, a second sensor configured to measure a temperature of water exiting the bypass chamber, and a controller electrically connected to the first sensor and the second sensor and configured to cause rotation of the flow director.

10. The hot water system according to claim 9, wherein the hot water system further comprises an actuator coupled to and configured to rotate the flow director, and wherein the controller is configured to cause the actuator to rotate the flow director based on data received from the first sensor and the second sensor in order to change the temperature of water exiting the bypass chamber.

11. The hot water system according to claim 8, wherein the hot water system comprises a single valve between the cold inlet and the hot outlet, and wherein the single valve is the rotational valve.

12. The hot water system according to claim 8, wherein the flow director is substantially cylindrical-shaped.

13. The hot water system according to claim 12, wherein the flow director comprises a body having a first grooved region and a second grooved region, wherein the first grooved region is configured to direct the water from the cold inlet into the bypass chamber, and wherein the second grooved region is configured to direct the water from the hot outlet into the bypass chamber.

14. The hot water system according to claim 13, wherein the first grooved region defines a first opening in the flow director, wherein the second grooved region defines a second opening in the flow director, and wherein the first opening is smaller than the second opening.

15. The hot water system according to claim 13, wherein the flow director further comprises a drive shaft extending outwardly from the body, and wherein the drive shaft is structured to be coupled to an actuator.

16. The hot water system according to claim 13, wherein the bypass chamber comprises a third conduit and a fourth conduit, wherein the third conduit and the fourth conduit are each configured to receive a corresponding one of the water from the cold inlet and the water from the hot outlet, after the water from the cold inlet and the water from the hot outlet have passed through a corresponding one of the first grooved region and the second grooved region.

17. The hot water system according to claim 16, wherein the bypass chamber further comprises a fifth conduit extending from and structured to receive water from the third conduit and the fourth conduit.

18. A method of operating a hot water system with a single valve, the hot water system comprising a tank having a cold inlet and a hot outlet, the method comprising:
positioning a rotational valve between the cold inlet and the hot outlet;
determining a temperature of water in the tank and a temperature of water exiting the rotational valve;
rotating, based on the temperature of water in the tank and the temperature of water exiting the rotational valve, the rotational valve in order to change the temperature of water exiting the rotational valve.

19. The method according to claim 18, wherein the rotational valve comprises:
a housing comprising a body, a first conduit configured to be coupled to the cold inlet, a second conduit configured to be coupled to the hot outlet, and a bypass chamber; and
a flow director disposed within the body and configured to rotate about an axis within the body in order to direct water from the cold inlet and water from the hot outlet into the bypass chamber.

20. The method according to claim 19, wherein the flow director comprises a body having a first grooved region and a second grooved region, wherein the first grooved region is for directing water from the cold inlet into the bypass chamber, wherein the second grooved region is for directing water from the hot outlet into the bypass chamber, and wherein causing the flow director to rotate comprises changing a flow rate of the water passing through the first and second grooved regions.
